(19) United States
(12) Patent Application Publication
(10) Pub. No.: US 2026/0066155 A1
(43) Pub. Date: Mar. 5, 2026

(54) MONOLITHIC FUNCTIONAL CERAMIC ELEMENT AND METHOD FOR PRODUCING A CONTACT FOR A FUNCTIONAL CERAMIC

(71) Applicant: TDK Electronics AG, Muenchen (DE)

(72) Inventors: Stephan Bigl, Graz (AT); Daniel Bretterklieber, Preding (AT); Michael Krenn, Dobl-Zwaring (AT)

(21) Appl. No.: 19/105,280

(22) PCT Filed: Aug. 25, 2023
(86) PCT No.: PCT/EP2023/073414

§ 371 Date: Feb. 20, 2025

(30) Foreign Application Priority Data
Aug. 30, 2022 (DE) 10 2022 121 865.1

(51) Int. Cl. H01C 7/02; C04B 35/64; C04B 37/00; H01C 17/28

(52) U.S. Cl. CPC H01C 7/02; C04B 35/64; C04B 37/003; H01C 17/281; C04B 2237/12; C04B 2237/343; C04B 2237/346; C04B 2237/704; C04B 2237/74

(57) ABSTRACT

In embodiments a method for providing a contacting for a functional ceramic element includes providing a functional ceramic, applying a metal paste to two opposing surfaces of the functional ceramic, laminating ceramic substrate green films on the metal paste on the two opposite surfaces of the functional ceramic, and jointly sintering the functional ceramic, the ceramic substrate green films forming electrically insulating ceramic layers and the metal paste forming electrically conductive metal structures.

### CROSS-REFERENCE TO RELATED APPLICATIONS

This patent application is a national phase filing under section 371 of PCT/EP2023/073414, filed Aug. 25, 2023, which claims the priority of German patent application no. 102022121865.1, filed Aug. 30, 2022, each of which is incorporated herein by reference in its entirety.

### TECHNICAL FIELD

The present invention relates to a functional ceramic element, a method for producing a contacting of a functional ceramic and the use of the element in a heating module.

### BACKGROUND

The use of functional ceramic elements in heating modules, in particular the use of PTC (“Positive Temperature Coefficient”) thermistor elements, has the advantage that due to their property as a temperature-dependent resistor, the power consumption is automatically limited when a certain temperature is reached. In particular, this property prevents the heating module from being overloaded.

Such heating modules are increasingly being used as heating registers in electric vehicles. Such use requires the register to be operated directly with the high-voltage battery (typically 200-800 V). The insulation strength must therefore be designed accordingly.

PTC elements are usually electrically contacted on two opposite sides by means of a conductor track. The conductor track is supported by a substrate, which decouples the heat generated on the other side.

The heat output that can be extracted depends heavily on the thermal path through the layer structure described above. Heat must travel from the point of origin (the PTC) via the contacting and through the substrate to the decoupling surface. Here, thermal and electrical considerations for optimizing the heating element are often subject to opposing arguments, i.e. state-of-the-art designs are compromise solutions between power density, thermal agility and insulation capacity or robustness and reliability.

The PTC element itself acts as a heat source when Joule heat is generated by energization. However, this is not generated homogeneously in the material, but depending on the geometry and possible material inhomogeneities, the electric field distribution in the component can cause a temperature gradient. Starting from hotspots, the heat must first reach the surface of the elements before it can be transported further. Due to the relatively poor thermal conductivity of the PTC ceramic (usually ˜5 W/mK), this may happen very slowly and sluggishly.

The document DE 11 2017 006 124 T5 describes a corresponding electrical heating device according to the state of the art with insulation layers between conductor tracks and cooling fins.

The document EP 1 182 908 A1 describes a similar PTC heating device with at least one PTC element and two contact plates that contact the PTC element. A metal foil coated with adhesive on both sides is provided to connect the surface of the PTC element to the contact plates. Insulation of the contact plates is not provided here.

A PTC heater with reduced inrush current is also known from the document DE 2017 101 946 A1.

Document DE 10 2016 108 604 A1 also describes how a similar functional ceramic can be embedded in a ceramic substrate.

### SUMMARY

Embodiments provide an improved functional ceramic element that can also be used in a heating module.

Embodiments relate to a method for producing a contacting of a functional ceramic, in particular a PTC ceramic, or a method for producing a functional ceramic element, in particular a, preferably monolithic, thermistor element. The method comprises at least the steps described below.

In a first step, a functional ceramic is provided. The ceramic referred to below as the functional ceramic is preferably a thermistor ceramic and even more preferably a PTC ceramic.

The functional or PTC ceramic can be provided in the green state or in the sintered state. Preferably, the functional ceramic is provided as a film in the green state, whereby the film has a low film thickness compared to the film surface. Only in the sintered state does the functional ceramic exhibit its desired functionality. In the present application, a functional ceramic is also referred to as a green ceramic that only exhibits functionality in the sintered state. The same applies to a PTC ceramic.

The functional ceramic can contain any suitable ceramic material. Possible ceramic materials are barium titanate ceramics, for example. Furthermore, the ceramic can also include lead and/or strontium, for example. The ceramic can also be doped with suitable dopants such as yttrium or manganese in suitable quantities in order to provide a desired functionality, in particular a thermistor functionality.

In a further step, metal paste is applied to two opposing surfaces of the functional ceramic.

The metal paste is preferably applied with a thickness of a few micrometers or a few 100 nanometers.

The metal paste preferably comprises an electrically conductive metal such as nickel, cobalt, copper, silver, another precious metal or a metal alloy in powder form. The metal paste also comprises suitable suspending agents, for example.

In one embodiment, the metal paste can be applied in a form that can be converted into comb-shaped metal structures by a sintering step, rather than in a flat form. In particular, the metal paste can be applied in a comb structure for this purpose. Preferably, the two comb structures are applied to the opposing surfaces in such a way that the comb structures do not lie on top of each other, but are offset. The comb structures each comprise a continuous section as the main strand and sections branching off from it as secondary strands.

The metal paste can be applied by (screen) printing or sputtering, for example.

In a further step, ceramic substrate green films are applied to the two opposing surfaces of the functional ceramic and laminated.

The ceramic substrate green films can comprise a ceramic material similar to the functional ceramic or another ceramic material. The ceramic material, which is formed from the ceramic substrate green films after sintering, is preferably electrically insulating and has good thermal conductivity.

The ceramic substrate green films are applied in such a way that they preferably cover the entire surface of the functional ceramic and the metal paste applied to it. The ceramic substrate green films are applied directly to the surface of the functional ceramic or to the metal paste applied to it.

The steps described above, which are preferably carried out in the order indicated, provide a layer stack comprising the two ceramic substrate green films, which enclose the functional ceramic in a sandwich-like structure. Structures made of metal paste are also arranged between the functional ceramic and the ceramic substrate green films, which are used to establish electrical contact with the functional ceramic.

In a further step, the layer stack is sintered together to form the functional ceramic element.

In a preferred embodiment, the functional ceramic element is monolithic. “Monolithic” means that the functional ceramic element does not consist of various individual elements, but of a single element. This means that no (sub-) elements need to be mechanically connected or bonded.

In one embodiment, the functional ceramic element is a monolithic thermistor element.

The term “sintering” here refers in particular only to the temperature treatment step so designated. In particular, the term “sintering” does not imply that everything that is sintered was previously in the green state. Structures that have already been sintered can also be subjected to a corresponding temperature treatment step, which then has little or no effect on the structures that have already been sintered.

The functional ceramic element is preferably a thermistor element with thermistor functionality. The functional ceramic is then a ceramic with thermistor properties, in particular an NTC or preferably a PTC ceramic.

The monolithic functional ceramic element is formed by jointly sintering the functional ceramic to form a functional ceramic layer, the ceramic substrate green films to form electrically insulating ceramic layers and the metal paste to form electrically conductive metal structures.

The functional ceramic element formed in this way therefore comprises the functional ceramic layer, the electrically insulating ceramic layers and the electrically conductive metal structures.

By forming a monolithic functional ceramic element, defects that occur when assembling a functional ceramic element from different sub-elements can be avoided. For example, cavities that can occur during bonding can be avoided. Furthermore, leakage or smearing of adhesive can be avoided. Furthermore, an incomplete connection between separate functional ceramic elements and insulating ceramic elements can be avoided.

The process is also simplified as there is no need to assemble different sub-elements.

By forming a functional ceramic layer, electrically conductive structures and insulating ceramic layers in a monolithic element, the stability and durability of the functional ceramic element can be increased.

Furthermore, this improves the thermal coupling between the individual layers, so that when a functional ceramic layer designed as a thermistor layer is heated by applying an electrical voltage, the resulting heat can be easily dissipated to the outside via the electrically insulating ceramic layers. The ceramic layers are preferably thin for this purpose

The use of film technology in the production of the functional ceramic element means that a large-area and very thin functional ceramic element can be provided. The thickness of the functional ceramic element can therefore be reduced. Furthermore, a functional ceramic film can replace several conventional functional ceramic bricks, e.g. PTC bricks, each with significantly smaller surface dimensions.

The thin films also allow the formation of a homogeneous electric field and thus, in the case of a thermistor element, homogeneous heating of the thermistor element, even without applying the electrically conductive structures over a large area.

The functional ceramic element can also be easily produced using existing automated processes for manufacturing multilayer ceramic elements.

By manufacturing a monolithic functional ceramic element, it is also possible to dispense with the provision of individual components such as conventional functional ceramic bricks or insulating ceramic components and electrically conductive metal foils, which have to be manufactured at different locations and then assembled.

The electrically conductive metal structures can be electrically contacted to the outside. Recesses in the electrically insulating ceramic layers are provided for this purpose, for example. The recesses can be formed, for example, by incompletely covering the metal structures with ceramic films or by later removing ceramic material.

In the area of the recesses, the metal structures can then be electrically contacted with wires, for example. The wires are soldered to the metal structures, for example. Alternatively, the metal structures can be electrically contacted using clamp contacts, for example. Other suitable contacting methods are also possible.

Preferably, the metal structures do not extend to the edge of the ceramic layers in order to form an area at the edges of the functional ceramic element that is not subjected to an electrical voltage even during operation.

In one embodiment, the functional ceramic is provided as a functional ceramic film in the green state. In one embodiment, the functional ceramic is provided in particular as a film in the green state and the metal paste and the ceramic substrate green films are applied directly to the functional ceramic film in the green state. Preferably, no further processing steps are carried out between the aforementioned steps. In an alternative embodiment, functional ceramics are provided as a film in the green state and the green functional ceramic is first sintered to form a functional ceramic layer. The metal paste and the ceramic substrate green films are then applied to the functional ceramic layer in the sintered state.

In one embodiment, the functional ceramic is provided as a green film and is sintered at high temperatures above 1000° C., preferably above 1300° C., before the metal paste and the ceramic substrate green films are applied, in order to form the functional ceramic layer. The functional ceramic then preferably comprises an HTCC (high temperature cofired ceramics) ceramic material.

Preferably, the metal paste is dried at an elevated temperature before sintering in order to vaporize a suspension or solvent.

In an alternative embodiment, the functional ceramic is provided in a sintered state.

The ceramic substrate green films preferably comprise an LTCC (low temperature cofired ceramics) ceramic material. The subsequent joint sintering is preferably carried out at a lower temperature below 1000° C., preferably below 800° C.

Sintering at low temperatures means that the thermistor functionality of the functional ceramic, for example, remains unchanged. In particular, subsequent sintering at low temperatures prevents undesirable oxidation of the functional ceramic.

In an alternative embodiment, the metal paste and the ceramic substrate green films are applied to the functional ceramic provided as a film in the green state. The stack of layers formed in this way is then sintered together. The joint sintering is preferably carried out at a high temperature above 1000° C., preferably above 1300° C.

In the present embodiment, both the functional ceramic and the other ceramic layers preferably comprise an HTCC ceramic.

This means that the ceramics can be sintered at the same temperature. By choosing ceramics that are as similar as possible, the development of mechanical stresses during sintering can also be reduced or avoided.

In a preferred embodiment, the functional ceramic film and the ceramic substrate green films have essentially the same composition.

Preferably, the composition of the functional ceramic film and the ceramic substrate green films differs only in the proportions of dopants in the composition. Such dopants can be yttrium or manganese, for example. In particular, the electrical resistance of the ceramic material can be increased by a higher proportion of the aforementioned dopants, thus providing an electrically insulating ceramic material.

In general terms, it may be preferred that the functional ceramic film and the ceramic substrate green films have the same ceramic base material, whereby the PTC functionality or the substrate function is set or defined via the choice of dopants and/or the concentration of the dopants.

By selecting ceramics that are as similar as possible for the various ceramic layers, the formation of mechanical stresses during sintering can be reduced or avoided. This prevents the formation of defects in the functional ceramic element, for example the formation of cavities between the layers. Furthermore, the selection of similar materials improves the thermal coupling between individual layers.

In a preferred process, several functional ceramic films are separated from a functional ceramic film of larger dimensions. This enables simple serial production of the functional ceramic elements. By separating the functional ceramic from the film, a large-area but very thin functional ceramic can be provided in a simple manner.

The functional ceramic films are separated by cutting or punching, for example.

Each individual functional ceramic film preferably has a rectangular shape with dimensions of at least 3 cm×10 cm. The thickness of the film is preferably a maximum of 150 μm. The dimensions of the functional ceramic layer are then smaller in accordance with the usual sintering shrinkage.

Embodiments also relate to a monolithic functional ceramic element, in particular a monolithic thermistor element. The functional ceramic element is preferably manufactured according to the method described above. All features and embodiments described in relation to the method can also apply to the functional ceramic element. In particular, the functional ceramic element can be a thermistor element in all embodiments and embodiment examples.

In particular, the embodiments also relate to a monolithic functional ceramic element, preferably a monolithic thermistor element, comprising at least the following layers laminated in a stacking direction perpendicular to an outer surface of the monolithic functional ceramic element.

All features and embodiments described in relation to the method can also apply to the monolithic functional ceramic element.

On the one hand, the monolithic functional ceramic element comprises a functional ceramic layer, preferably a PTC ceramic layer, with two opposing surfaces.

Furthermore, the monolithic functional ceramic element comprises two electrically conductive metal structures with different polarity in the operating state, which are each arranged in direct contact on one of the opposing surfaces of the functional ceramic layer. “Direct contact” means that the electrically conductive metal structures lie directly on the surfaces of the functional ceramic layer and no other intermediate structures are formed.

The electrically conductive metal structures are also electrically connected to the electrically conductive functional ceramic layer. This means that an electric field can be applied to the functional ceramic layer via the electrically conductive metal structures or an electric voltage can be applied.

Furthermore, the functional ceramic element comprises two electrically insulating ceramic layers, each of which is arranged on one of the opposing surfaces of the functional ceramic layer and the metal structures arranged thereon. The electrically insulating ceramic layers lie directly on the surface of the functional ceramic layer or the metal structures.

In one embodiment, the functional ceramic layer comprises or consists of an HTCC ceramic and the electrically insulating ceramic layers comprise or consist of an LTCC ceramic.

Preferably, the electrically insulating ceramic layers in this embodiment comprise an aluminum oxide ceramic.

The electrically insulating ceramic layers should also have good thermal conductivity, i.e. be made of a material with high thermal conductivity.

In an alternative embodiment, the functional ceramic layer and the electrically insulating ceramic layers each comprise or consist of an HTCC ceramic.

Preferably, the functional ceramic layer and the electrically insulating ceramic layers then have essentially the same ceramic composition.

In one embodiment, the ceramic composition of the functional ceramic layer and the electrically insulating ceramic layers differ only in the proportion of dopants in the ceramic composition.

Such a functional ceramic element has a particularly high thermal coupling between the individual layers, which is advantageous for use as a thermistor element in a heating module, for example.

In any embodiment, the functional ceramic layer comprises a barium titanate ceramic which may further comprise, for example, a strontium compound such as strontium oxide and/or a lead compound such as lead oxide and a dopant such as yttrium or manganese.

In one embodiment, the functional ceramic layer has a maximum layer thickness of 150 μm. Preferably, the functional ceramic layer has a lower layer thickness of maximum 100 μm or maximum 50 μm. The layer thickness should be at least 40 μm.

A homogeneous electric field can easily be generated in such a thin layer. Even with non-surface metal structures, for example in the form of a comb, it is possible to apply an electric field that forms evenly over the entire area of the functional ceramic layer covered by the metal structures.

In one embodiment, the electrically insulating ceramic layers have a maximum layer thickness of 200 μm.

The insulating ceramic layers preferably cover the entire functional ceramic layer along the two opposing surfaces. Due to the thin design of the layers, the dimensions of the entire functional ceramic element can be reduced.

The thin insulating ceramic layers also enable good heat conduction to the outside of the functional ceramic element.

According to one embodiment, the functional ceramic element has a maximum thickness of 800 μm, preferably 500 μm, even more preferably 400 μm in a stacking direction of the aforementioned layers.

In one embodiment, the electrically conductive metal structures are formed in a comb structure.

The comb structures each comprise a continuous section and several sections branching off from the continuous section. Preferably, the electrically conductive metal structures are not arranged one above the other in the stacking direction so that, during operation, all conductive paths in the functional ceramic layer, via which electrical current is conducted through the functional ceramic layer, run diagonally. In this way, a minimum conductive path through the layer of preferably at least 4 mm can be provided despite the low thickness of the functional ceramic layer.

The minimum conduction path, i.e. the shortest path along which current can flow between two metal structures with different polarity during operation, is preferably formed in the functional ceramic layer between two branching sections of one of the electrically conductive metal structures in each case.

The formation of the comb structure also means that metallic material can be saved.

The minimum conductive path guaranteed in this way means that prescribed creepage distances can be maintained, so that the desired insulation strength is achieved and the thickness of the functional ceramic layer can be further reduced at the same time. Despite the low film thickness, electrical voltages of preferably 450 volts to 800 volts and even more preferably up to 1000 volts can be applied.

The guaranteed minimum conduction path can also reduce the maximum current flow when a certain electrical voltage is applied to the ceramic layer. This can reduce the energy consumption of a connected battery, for example. Furthermore, inrush current peaks, which represent a high load for the battery or for the connected switching electronics, can be reduced.

Embodiments further relates to a heating module comprising one or more of the monolithic thermistor elements described above.

The improved heat coupling, heat conduction and heat transfer properties of the monolithic thermistor element described above can increase the efficiency of the heating module.

The heating module is, for example, a finned heating module comprising several of the described monolithic thermistor elements, on the surfaces of which fins are applied through which a thermal fluid flows. The thermal fluid is heated by the thermistor elements during operation. A corresponding heating module can be used in the automotive sector, for example, and should preferably have a heat output of at least 5 kW (kilowatt).

### BRIEF DESCRIPTION OF THE DRAWINGS

The invention is described in more detail below with reference to examples of embodiments and associated figures.

The invention is not limited to the examples shown in the figures.

Similar or apparently identical elements in the figures are marked with the same reference symbol. The figures and the proportions in the figures are not necessarily true to scale.

FIG. 1 shows a schematic representation of the manufacturing process of a first example of a monolithic thermistor element;

FIG. 2 shows across-section of a first example of the monolithic thermistor element with the minimum conduction path shown;

FIG. 3 shows a microscopic image of a section in the edge area of the first embodiment of the monolithic thermistor element;

FIG. 4 shows a microscopic image of a cross-section through a second example of a monolithic thermistor element;

FIG. 5 shows a top view of an example of the monolithic thermistor element with external contacting by wires;

FIG. 6 shows a change in the cold resistance of a PTC ceramic layer of an exemplary thermistor element according to embodiments as a function of the number of cycles. In each cycle, 450 volts DC is applied to the thermistor element for 5 seconds and then cooled for 30 seconds;

FIG. 7 shows an inrush current curve of the exemplary thermistor element according to embodiments. The current flow I through a PTC ceramic layer when a DC voltage U of 450 volts is applied is shown as a function of the time t from switch-on; and

FIG. 8 shows a photograph of a heating module comprising monolithic thermistor elements.

### DETAILED DESCRIPTION OF ILLUSTRATIVE EMBODIMENTS

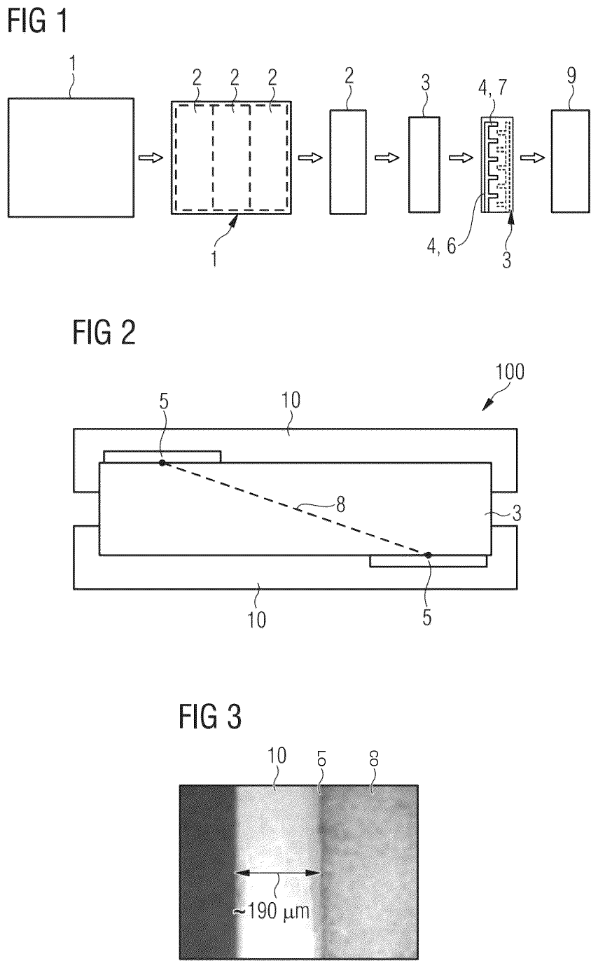

FIG. 1 shows the manufacture of a first example of a functional ceramic element according to embodiments. In this example, it is in particular a monolithic thermistor element 100.

In a first step, a PTC ceramic film 1 is provided as a functional ceramic film with a large surface area and a low thickness. The expansion of the large PTC ceramic film 1 is, for example, 4 inches×4 inches. The expansion can alternatively be any other, preferably larger dimension. The thickness of the PTC ceramic film 1 is between 40 and 250 micrometers, preferably between 50 and 150 micrometers, more preferably less than 100 micrometers.

Any number of PTC ceramic films 2 with a smaller expansion can be separated from the large PTC ceramic film 1 provided. The individual PTC ceramic films 2 are punched or cut out of the large PTC ceramic film 1, for example.

For example, three PTC ceramic films 2 are separated from the exemplary large PTC ceramic film 1 with an extension of 4 inches×4 inches. The separated PTC ceramic films 2 preferably have a rectangular shape with an extension of approx. 3 cm×10 cm each. The PTC ceramic films 2 can also have larger dimensions than 3 cm×10 cm.

Compared to conventionally used PTC ceramic bricks, the PTC ceramic films 2 produced in this way have a significantly larger surface area with a smaller thickness. This means that a monolithic thermistor element comprising a single PTC ceramic film 2 can be produced, whereas a large number of PTC ceramic bricks are used in conventional processes. Furthermore, the thickness of the thermistor element can be reduced by using the thin PTC ceramic film 2.

The separated PTC ceramic films 2 are sintered in a subsequent step. Preferably, the PTC ceramic films 2 are sintered at a high temperature, for example between 1240° C. and 1320° C., to produce the desired thermistor functionality.

During sintering, the expansion of the PTC ceramic film 2 is reduced by an amount typical of sintering shrinkage. Sintering converts the green PTC ceramic film 2 into a sintered functional ceramic layer, namely a PTC ceramic layer 3. The surface area of the PTC ceramic layer 3 is, for example, 26 mm×78 mm and preferably no more than 3 mm×9 mm.

Electrically conductive metal structures 5 are then applied to the sintered PTC ceramic layer 3. For this purpose, for example, a metal paste 4 is printed or sputtered onto the two opposing surfaces of the PTC ceramic layer 3. Preferably, the metal paste 4 is applied in the form of a comb.

The metal paste 4 comprises, for example, nickel, copper, aluminum, a precious metal or an alloy of individual metals.

As shown in the illustrations, the comb comprises a continuous section 6, effectively the main strand of the comb, from which several sections 7 branch off, preferably at a right angle, effectively the secondary strands of the comb. The metal paste 4 is therefore not applied over the entire surface.

Although the metal paste 4 is not applied over the entire surface, the advantageous thin layer thickness of the PTC ceramic layer 3 according to embodiments enables the formation of a uniform electric field in the PTC ceramic layer 3 in the operating state. In particular, this leads to the fact that electric current is uniformly converted into thermal energy in the PTC ceramic layer 3 in the operating state.

The thermal energy is transferred to the environment via the other ceramic layers 10, which preferably conduct heat well. The heat dissipation to the environment is further favored by the good thermal coupling between the individual, jointly sintered layers of the monolithic thermistor element 100.

The two combs on the two surfaces of the PTC ceramic layer 3 are structured in such a way that they do not lie on top of each other in a direction perpendicular to the surface of the PTC ceramic layer 3. In other words, viewed from a direction from one of the surfaces of the PTC ceramic layer 3, both comb structures would be visible next to each other in the theoretical case of a transparent PTC ceramic layer 3. The continuous main strand 6 of the combs are applied to different sides of the respective surfaces. The branching sections 7 are each applied next to each other with recesses between them in such a way that the sections 7 of the two combs are not on top of each other, but each point in the direction of the other comb structure.

This structuring of the metal paste 4 and thus also of the electrically conductive metal structures 5 subsequently formed from it maximizes the conduction path 8 in the PTC ceramic layer 3 as shown in FIG. 2. Conduction path 8 is the distance that an electric current would travel in the PTC ceramic layer 3 in the operating state. The shortest conduction path 8 in the PTC ceramic layer 3 between two metal structures 5 should preferably be at least 4 mm. This shortest conduction path 8 is preferably formed between two adjacent branching sections 7 of one of the two electrically conductive metal structures 5 in each case.

Despite the low ceramic thicknesses, the minimum conduction path 8 described enables the application of high electrical voltages, for example in the range between 400 and 1000 volts, preferably in the range above 800 volts.

The applied metal paste 4 is then dried at a temperature of, for example, at least 180° C. for a period of, for example, at least 30 minutes.

Then, as shown in FIG. 3, a ceramic substrate green film 9 is applied to both surfaces of the PTC ceramic layer 3, covering the entire surface of the PTC ceramic layer 3 and the metal paste 4 applied to it. The thickness of the metal paste structure 4 is negligible compared to the thickness of the ceramic layers or films and is in the micrometer or sub-micrometer range.

While the PTC ceramic layer 3 preferably comprises a high-temperature sintered HTCC ceramic, the other ceramic layers 10, which are formed from the ceramic substrate green films 9, preferably comprise an LTCC ceramic material that is sintered at comparatively lower temperatures.

The material of the PTC ceramic layer 3 is, for example, a barium titanate ceramic or a similar material, which can also include other metals such as lead or strontium. Preferably, however, it is a lead-free ceramic. To produce the thermistor functionality, the ceramic of the PTC ceramic layer 3 is preferably doped with other elements such as yttrium and/or manganese.

The LTCC ceramic of the other ceramic layers 10 is, for example, an aluminum oxide ceramic or a similar material that is preferably a good thermal conductor but electrically insulating.

The ceramic substrate green films 9 preferably have a film thickness of between 50 and 200 micrometers.

After the ceramic substrate green films 9 have been laminated, the entire stack of layers is pressed and sintered together. Preferably, sintering takes place at low temperatures, for example between 85° and 950° C. in an air atmosphere, so that the ceramic substrate green films 9 are converted into electrically insulating ceramic layers 10 and the metal paste 4 is converted into electrically conductive metal structures 5.

The lower sintering temperature during joint sintering ensures that the PTC ceramic layer 3 is not or hardly oxidized, so that the desired thermistor functionality is retained.

For an alternative embodiment, the procedure can be slightly modified. In the modified method, all steps that are not described again in detail are carried out analogously to the previous method. In contrast to the previously described method, in the modified method the PTC ceramic film 2 is not sintered before the metal paste 4 and the ceramic substrate green films 9 are applied. Instead, the metal paste 4 and the ceramic substrate green films 9 are applied to the non-sintered, green PTC ceramic film 2.

In contrast to the process described above, it is necessary for the ceramic substrate green films 9 to have a similar material to PTC ceramic film 2. The ceramic substrate green films 9 therefore comprise an HTCC ceramic like the PTC ceramic film 2.

Preferably, the PTC ceramic film 2 and the ceramic substrate green films 9 essentially comprise the same ceramic material, which differs only in the amount of added doping elements. A suitable material would be, for example, a barium titanate ceramic with a boron nitride sintering additive. The thermistor functionality of the PTC ceramic layer 3 or the electrically insulating property of the other ceramic layers 10 is adjusted by the amount of doping with other elements such as yttrium and/or manganese.

Alternatively, two different HTCC ceramics can also be selected for the PTC ceramic film 2 and the ceramic substrate green films 9.

The entire stack, comprising the films 2 and 9 and the metal paste 4, is sintered together at a high temperature. An exemplary sintering temperature is between 100° and 1300° C. For example, the stack is sintered at 1150° C.

In a subsequent step, the formed monolithic thermistor element 100 can be reoxidized by heating it to 600 to 800° C. in an air atmosphere to produce the thermistor functionality of the PTC ceramic layer 2.

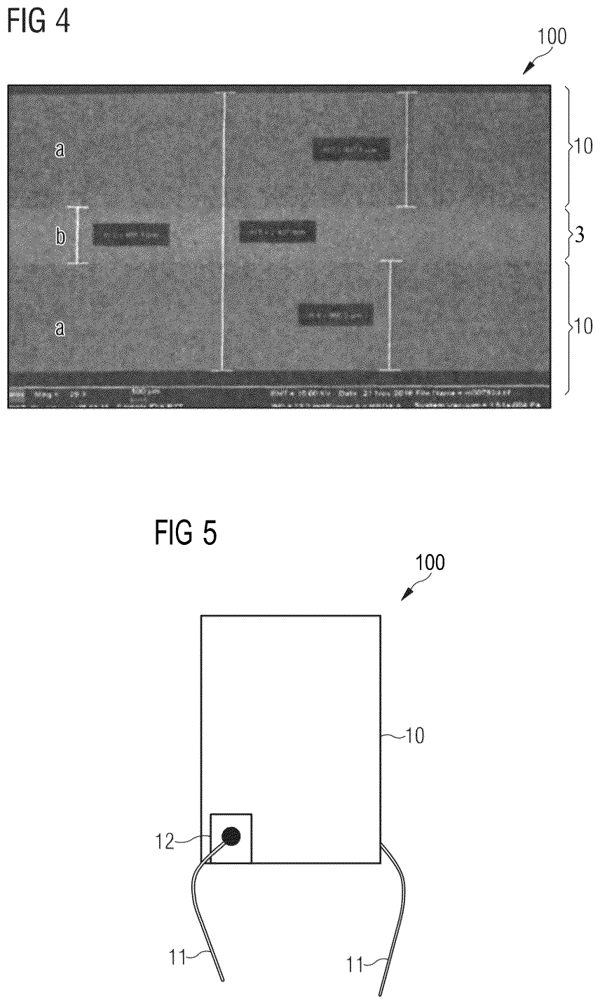

A scanning electron micrograph of a cross-section through a correspondingly manufactured monolithic thermistor element 100 is shown in FIG. 4.

For external electrical contacting, for example, wires 11 can then be connected to the electrically conductive structures 5, as shown in FIG. 5.

For example, the wires 11 are soldered onto a surface of the electrically conductive structures 5 for this purpose. For this purpose, recesses 12 can be provided in the electrically insulating ceramic layers 10 or formed subsequently by removing the ceramic material at the corresponding points. Preferably, these recesses 12 are formed at corners or close to the corners of the monolithic thermistor element 100.

The monolithic thermistor element 100 produced using the method described can be made significantly thinner than previously known thermistor elements. The layer structure described and the joint sintering of the entire layer stack to form a monolithic element eliminate additional assembly steps such as pressing and gluing individual components. By eliminating these steps, possible assembly errors such as the formation of gaps or cavities between the individual elements are also avoided or minimized. The reliability of the thermistor element 100 in operation and the durability of its functionality over time can thus be increased.

Furthermore, the method described enables flexible production of thermistor elements 100 of different dimensions and with different desired electrical properties using established automated manufacturing processes from multilayer ceramic technology.

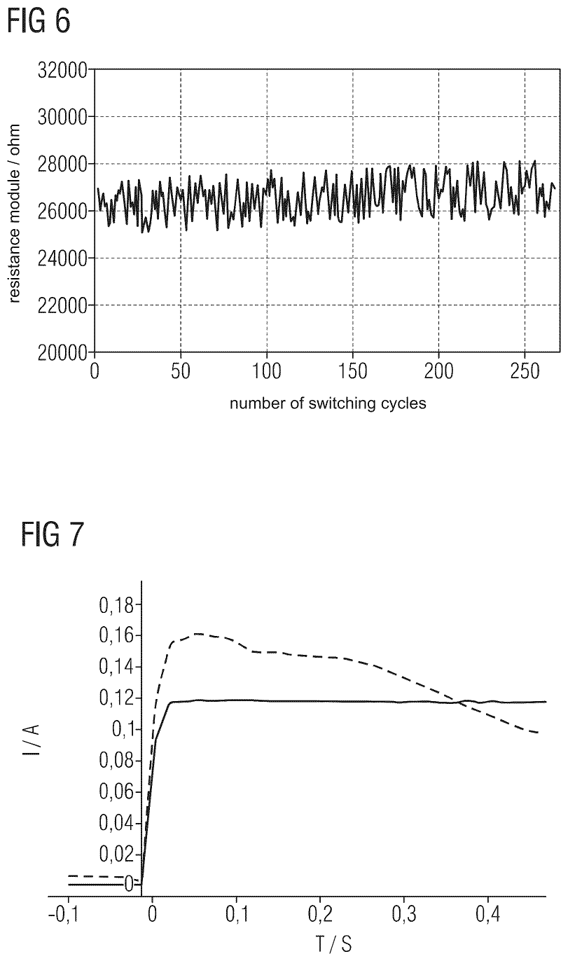

FIG. 6 shows an example diagram of the cold resistance of the PTC ceramic layer 3 as a function of the number of switching cycles. In each switching cycle, a DC voltage of 450 volts is applied to the PTC ceramic layer for 5 seconds and the current is then switched off and the thermistor element 100 is cooled for 30 seconds. The cold resistance is measured in the cooled state. The next switching cycle then begins.

The diagram shows that the cold resistance hardly depends on the number of switching cycles, i.e. the properties of the thermistor element 100 do not change, for example due to the layers peeling off. The fluctuations shown are due to the short cycle times, which prevent a thermal equilibrium from being established.

FIG. 7 shows another diagram showing the inrush current curve for a monolithic thermistor element 100 according to embodiments. The thermistor element with a room temperature resistance of about 25 k (2 reaches the maximum inrush current or minimum electrical resistance after about 50 ms (milliseconds) at a direct current (DC) voltage of 450 volts applied to. In relation to the resistance-temperature data of the PTC ceramic used, this would correspond to a temperature of around 170° C. The voltage curve is also shown in steps in the diagram.

Due to the comparatively long conduction path 8 caused by the diagonal arrangement of the electrically conductive structures 5 on the PTC ceramic layer 3, the current peak after the current is switched on, which can be seen in the diagram at approx. 50 ms, can be reduced. This reduces the current consumption and protects the stressed material.

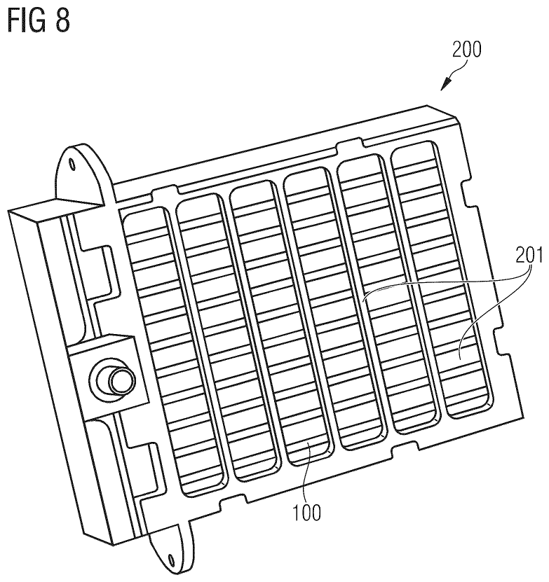

The monolithic thermistor element 100 according to embodiments is preferably used in a heating module 200. The heating module 200, which is shown in FIG. 8, comprises several, for example six, thermistor elements 100.

Lamellar structures 201 are then applied to the surface of the electrically insulating but highly thermally conductive ceramic layers 10, through which a fluid heating medium is guided.

The heating medium is heated as it flows through the lamellar structures 201 and can then release the heat at the points to be heated.

Corresponding heating modules are used, for example, in the automotive sector to heat the passenger compartment or in the electric vehicle sector to heat the battery to a uniform, desired temperature, for example 40° C. The heating output of such a heating module 200 should preferably be at least 5 kW.

Due to the monolithic structure of the thermistor element 100, there are no special requirements, such as a high mechanical drive force, when assembling the heating module 200.

1.-31. (canceled)

32. A method for providing a contacting for a functional ceramic element, the method comprising:
providing a functional ceramic;
applying a metal paste to two opposing surfaces of the functional ceramic;
laminating ceramic substrate green films on the metal paste on the two opposite surfaces of the functional ceramic; and
jointly sintering the functional ceramic, the ceramic substrate green films forming electrically insulating ceramic layers and the metal paste forming electrically conductive metal structures.

33. The method according to claim 32, wherein the functional ceramic is a functional ceramic film in a green state.

34. The method according to claim 33, wherein several functional ceramic films are separated from a functional ceramic film of larger dimensions.

35. The method according to claim 34, wherein each functional ceramic film has a rectangular shape with a dimension of at least 3 cm×10 cm.

36. The method according to claim 33, wherein, in addition to the functional ceramic film, ceramic substrate green films are also applied in a green state and are converted into a non-green, sintered state by a common sintering step.

37. The method according to claim 32, wherein the functional ceramic is a thermistor ceramic.

38. The method according to claim 37, wherein the functional ceramic is a PTC ceramic.

39. The method according to claim 32, wherein the functional ceramic element is a monolithic functional ceramic element.

40. The method according to claim 32, wherein the functional ceramic is provided in a sintered state.

41. The method according to claim 32, wherein the functional ceramic is provided as a film in a green state and is sintered at high temperatures above 1000° C. to form a functional ceramic layer before the metal paste and the ceramic substrate green films are applied, and wherein the subsequent to joint sintering to form the functional ceramic element is carried out at a lower temperature below 1000° C.

42. The method according to claim 32, wherein the functional ceramic is a functional ceramic film in a green state, wherein the metal paste and the ceramic substrate green films are applied to the functional ceramic in a green state, and wherein the subsequent joint sintering to form the functional ceramic element is carried out at a high temperature above 1000° C.

43. The method according to claim 42, wherein the functional ceramic film and the ceramic substrate green films have essentially the same composition and the composition of the functional ceramic film and the ceramic substrate green films differ only in proportion of dopants in the composition.

44. The method according to claim 32, wherein the metal paste is applied in a structure which is converted into comb-shaped metal structures by jointly sintering.

45. A monolithic functional ceramic element comprising:
a functional ceramic layer with two opposing surfaces;
two electrically conductive metal structures with different polarity during operation, which are each arranged in direct contact on one of the opposing surfaces of the functional ceramic layer; and
two electrically insulating ceramic layers, each arranged on one of opposing surfaces of the functional ceramic layer and the metal structures arranged thereon
wherein the layers are laminated in a stacking direction perpendicular to an outer surface of the functional ceramic element.

46. The monolithic functional ceramic element according to claim 45, wherein the functional ceramic layer comprises or consists of an HTCC ceramic and the electrically insulating ceramic layers comprise or consist of an LTCC ceramic.

47. The monolithic functional ceramic element according to claim 45, wherein the electrically insulating ceramic layers comprise an aluminum oxide ceramic.

48. The monolithic functional ceramic element according to claim 45, wherein each of the functional ceramic layer and the electrically insulating ceramic layers comprises or consists of an HTCC ceramic.

49. The monolithic functional ceramic element according to claim 48, wherein the functional ceramic layer and the electrically insulating ceramic layers have essentially the same ceramic composition and the ceramic composition of the functional ceramic layer and the electrically insulating ceramic layers differ only in proportion of dopants in the ceramic composition.

50. The monolithic functional ceramic element according to claim 45, wherein the functional ceramic layer comprises a barium titanate ceramic.

51. The monolithic functional ceramic element according to claim 45, wherein the electrically insulating ceramic layers have a high thermal conductivity.

52. The monolithic functional ceramic element according to claim 45, wherein the functional ceramic layer has a layer thickness of at most 150 μm.

53. The monolithic functional ceramic element according to claim 45, wherein the electrically insulating ceramic layers have a layer thickness of at most 200 μm.

54. The monolithic functional ceramic element according to claim 45, wherein the monolithic functional ceramic element has a thickness of at most 500 μm in the stacking direction.

55. The monolithic functional ceramic element according to claim 45, wherein the electrically conductive metal structures comprise a comb structure, each electrically conductive metal structure comprising a continuous section and a plurality of sections branching off from the continuous section.

56. The monolithic functional ceramic element according to claim 55, wherein the electrically conductive metal structures are not arranged one above the other in the stacking direction so that in operation all conduction paths in the functional ceramic layer, via which electric current is conductible through the functional ceramic layer, run diagonally.

57. The monolithic functional ceramic element according to claim 56, wherein a minimum conduction path in the functional ceramic layer between two branching sections of one of the electrically conductive metal structures in each case is at least 4 mm.

58. The monolithic functional ceramic element according to claim 45, wherein the monolithic functional ceramic element is a monolithic thermistor element.

59. The monolithic functional ceramic element according to claim 58, wherein the functional ceramic is a PTC ceramic.

60. A heating module comprising:
the monolithic thermistor element according to claim 58.

61. The monolithic functional ceramic element according to claim 45, wherein the functional ceramic layer is derived from a functional ceramic film having a dimension of at least 3 cm×10 cm.
